(19) United States
(12) Patent Application Publication
(10) Pub. No.: US 2015/0043094 A1
(43) Pub. Date: Feb. 12, 2015

(54) VARIABLE-SHAPE OPTICAL ELEMENT

(71) Applicant: Electronics and Telecommunications Research Institute, Daejeon (KR)

(72) Inventors: Ki-Uk KYUNG, Daejeon (KR); Sung-Ryul YUN, Daejeon (KR); Sun-Tak PARK, Incheon (KR); Bong-Je PARK, Daejeon (KR); Sae-Kwang NAM, Daegu (KR)

(73) Assignee: Electronics and Telecommunications Research Institute, Daejeon (KR)

(21) Appl. No.: 14/316,083

(22) Filed: Jun. 26, 2014

(30) Foreign Application Priority Data
Aug. 9, 2013 (KR) 10-2013-0095004

(51) Int. Cl. G02B 7/02

(52) U.S. Cl. CPC G02B 7/02
USPC 359/811

(57) ABSTRACT

Provided is a variable-shape optical element including a variable-shape lens, an actuator connected to the variable-shape lens, and a support configured to support the actuator. Here, the actuator may vary in shape according to an electrical signal.

### CROSS-REFERENCE TO RELATED APPLICATION

This application claims priority to and the benefit of Korean Patent Application No. 10-2013-0095004, filed on Aug. 9, 2013, the disclosure of which is incorporated herein by reference in its entirety.

### BACKGROUND

1. Field of the Invention

Exemplary embodiments broadly relate to a variable-shape optical element.

2. Discussion of Related Art

There is a lens that contracts or expands when an electric field is applied to two ends of a thin film structure using an electroactive polymer (EAP) or so on. For example, according to Korean Patent Application No. 10-2007-0073050, electrodes are formed on both sides of a polymeric film having a lens shape, and the polymeric film serves as a variable-shape lens. An optical element according to U.S. patent application Ser. No. 11/807,667 also has a similar structure. In spite of an advantage in expansion and contraction upon application of an electric field, a polymeric film has a limited variation in focal length due to its very small thickness.

Meanwhile, a variable-shape membrane disclosed in U.S. Pat. No. 8,363,330 includes a flexible lens unit and a plurality of actuating units installed around the flexible lens unit. Like a lever, the actuating units apply force to the flexible lens unit by mechanical movement caused by electrostatic force without a change in shape, leading to a change in the internal pressure. In this way, the lens is swelled or contracted, and the focal length of the flexible lens is adjusted.

### SUMMARY OF THE INVENTION

Exemplary embodiments provide an optical element in which it is possible to change both the position and the focal length of a variable-shape lens.

Illustrative, non-limiting embodiments may overcome the above disadvantages and other disadvantages not described above. The present invention is not necessarily required to overcome any of the disadvantages described above, and the illustrative, non-limiting embodiments may not overcome any of the problems described above. The appended claims should be consulted to ascertain the true scope of the invention.

According to an aspect of exemplary embodiments, there is provided a variable-shape optical element, including: a variable-shape lens; an actuator connected to the variable-shape lens; and a support configured to support the actuator. Here, the actuator may vary in shape according to an electrical signal.

According to an exemplary embodiment, the actuator may include a first actuator connected to a first portion of the variable-shape lens; and a second actuator connected to a second portion of the variable-shape lens.

According to an exemplary embodiment, the first portion and the second portion may be symmetric with respect to a center of the variable-shape lens.

According to an exemplary embodiment, the first actuator and the second actuator may be separately controlled.

According to an exemplary embodiment, the actuator may further include a third actuator connected to a third portion of the variable-shape lens; and a fourth actuator connected to a fourth portion of the variable-shape lens.

According to an exemplary embodiment, the third portion and the fourth portion may be symmetric with respect to the center of the variable-shape lens.

According to an exemplary embodiment, the third actuator and the fourth actuator may be separately controlled.

According to an exemplary embodiment, among the first actuator, the second actuator, the third actuator, and the fourth actuator, all pairs of actuators adjacent to each other may make the same angle with the center of the variable-shape lens.

According to an exemplary embodiment, the actuator may be formed of an electroactive polymer.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1A is a schematic diagram illustrating a process of forming an image on a human eye by adjusting the focal length of an eye lens;

FIG. 1B is a schematic diagram showing the disposition of muscles around an eyeball that cause motion of the eyeball;

FIG. 2 is a schematic diagram showing a variable-shape optical element according to an exemplary embodiment of the present invention;

FIG. 3A is a schematic diagram showing a state in which an actuator of FIG. 2 is expanded;

FIG. 3B is a plan view corresponding to FIG. 3A;

FIG. 3C is a schematic diagram showing a state in which the actuator of FIG. 2 is contracted;

FIG. 3D is a plan view corresponding to FIG. 3C;

FIG. 4A is a schematic diagram illustrating a method of adjusting the position of a variable-shape lens of FIG. 2;

FIG. 4B is a schematic diagram illustrating a method of adjusting the position of a variable-shape lens of FIG. 2;

FIG. 4C is a plan view corresponding to FIG. 4A;

FIG. 4D is a plan view corresponding to FIG. 4B;

FIG. 5 is a schematic diagram showing a variable-shape optical element according to another exemplary embodiment of the present invention; and

FIG. 6 is a schematic diagram showing an array structure including a plurality of variable-shape optical elements of FIG. 5.

### DETAILED DESCRIPTION OF EXEMPLARY EMBODIMENTS

Exemplary embodiments of the present invention will be described in detail below with reference to the accompanying drawings. In the following description and the appended drawings, substantially the same elements will be assigned the same reference numbers, and their description will not be reiterated. In the description of exemplary embodiments of the present invention, if it is determined that a detailed description of well-known functions or elements related to the invention may unintentionally obscure the subject matter of the invention, the detailed description will be omitted. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated elements, steps, operations, and/or devices, but do not preclude the presence or addition of one or more other elements, steps, operations, devices, and/or combinations thereof.

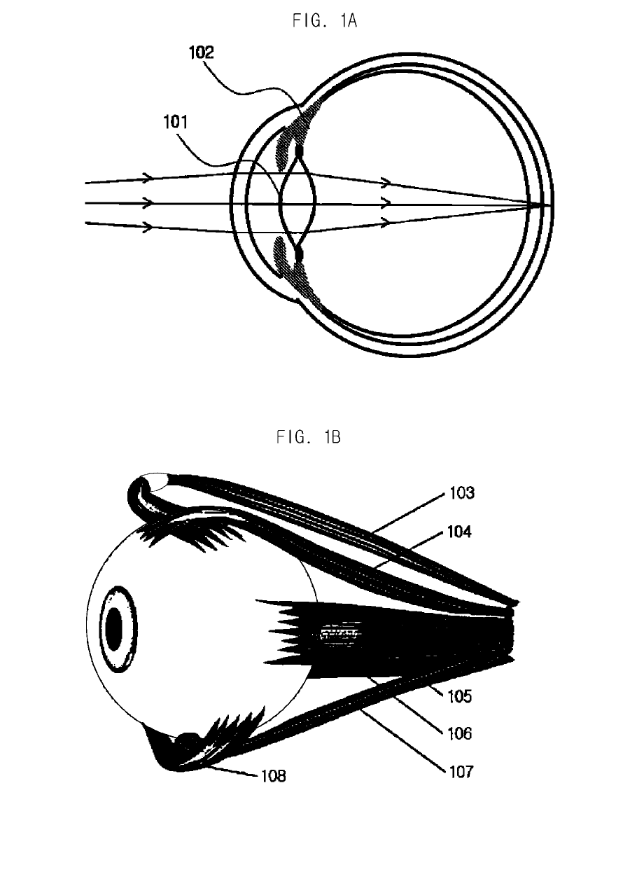

FIG. 1A is a schematic diagram illustrating a process of forming an image on a human eye by adjusting the focal length of an eye lens, and FIG. 1B is a schematic diagram showing the disposition of muscles around an eyeball that cause motion of the eyeball.

Referring to FIG. 1A, when information is received from surroundings using an eye, an image is formed on a retina by adjusting the degree of convexity of an eye lens 101 that serves as a convex lens according to the distance from an object.

When the distance from the object is short, the eye lens 101 generally becomes convex to reduce its focal length, causing an image to be formed on the retina. On the other hand, when the distance from the object is long, the eye lens 101 becomes less convex to increase its focal length, causing an image to be formed on the retina. At this time, muscles, such as a ciliary body 102, connected around the eye lens 101 to adjust the degree of convexity of the eye lens 101 are contracted or relaxed such that the focal distance of the eye lens 101 is adjusted.

Referring to FIG. 1B, there are a plurality of pairs of muscles 103, 104, 105, 106, 107, and 108 around an eyeball, and the eyeball rolls upwards, downwards, leftwards, and rightwards according to contraction and release of the respective muscles.

A variable-shape optical element according to an exemplary embodiment of the present invention employs the above-described eyeball motion, and will be described in detail below.

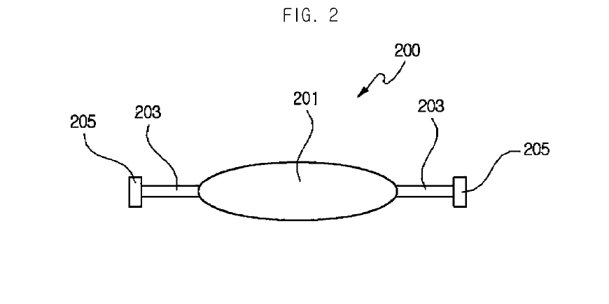

FIG. 2 is a schematic diagram showing a variable-shape optical element according to an exemplary embodiment of the present invention.

As shown in FIG. 2, a variable-shape optical element 200 according to an exemplary embodiment of the present invention includes a variable-shape lens 201, an actuator 203, and a support 205.

As an elastic transparent lens formed of a flexible material, the variable-shape lens 201 may correspond to the lens of a human eye. The variable-shape lens 201 may be in the form of a pouch filled with fluid or a flexible solid.

The actuator 203 is connected to the variable-shape lens 201, and varies in shape according to an electrical signal. By changing the shape of the actuator 203, it is possible to change the position of the variable-shape lens 201 or adjust the focal length of the variable-shape lens 201.

The actuator 203 may be formed of an electroactive polymer, a piezoelectric film, or so on. An example of an electroactive polymer is a dielectric elastomer. The dielectric elastomer may be manufactured in the form of a thin film and has high transparency.

Meanwhile, an electrode (not shown) that delivers the electrical signal to the actuator 203 may be included, and formed of a transparent and flexible material. For example, the electrode may be formed of grapheme, a metal nanowire, indium tin oxide (ITO), or so on. Therefore, when the actuator is manufactured with a film-type electroactive polymer to have electrodes on the upper and lower surfaces thereof respectively and a potential difference is generated by an external voltage applied between the two electrodes, the actuator 203 horizontally expands according to the potential difference and thus may vary in shape.

The actuator 203 may include a first actuator 203a connected to a first portion 201a of the variable-shape lens 201, and a second actuator 203b connected to a second portion 201b of the variable-shape lens 201. The first portion 201a and the second portion 201b of the variable-shape lens 201 are at different positions.

For example, the first portion 201a and the second portion 201b may be symmetric with respect to a center C of the variable-shape lens 201, and in this case, the first actuator 203a and the second actuator 203b may be symmetric to each other.

Meanwhile, the first actuator 203a and the second actuator 203b may be separately controlled. In other words, when the first actuator 203a expands or contracts, the second actuator 203b may expand or contract, or may not vary in shape. Likewise, when the second actuator 203b expands or contracts, the first actuator 203a may expand or contract, or may not vary in shape.

On the other hand, three or more actuators may be included, and even in this case, each actuator may be separately controlled. In addition, when an even number of actuators are included, it is easy to maintain a balance between the variable-shape lens 201 and the actuators, and a stable structure is achieved. For example, when four actuators are included, all pairs of actuators adjacent to each other may be disposed to make the same angle with the center C of the variable-shape lens 201. In this case, the actuators may be disposed in the form of a crisscross.

The support 205 surrounds the variable-shape lens 201 spaced apart at a predetermined distance from the variable-shape lens 201. For example, the support 205 may have a ring shape. The actuator 203 is connected to the inner cylindrical surface of the support 205 and supported by the support 205. In other words, one end of the actuator 203 is connected to the variable-shape lens 201, and the other end is connected to the support 205.

Although not shown in the drawing, the support 205 is fixed at another component. Therefore, even when the actuator 203 contracts or expands, the support 205 does not move. On the other hand, the variable-shape lens 201 receives contractile or expansion force of the actuator 203 and varies in shape or position.

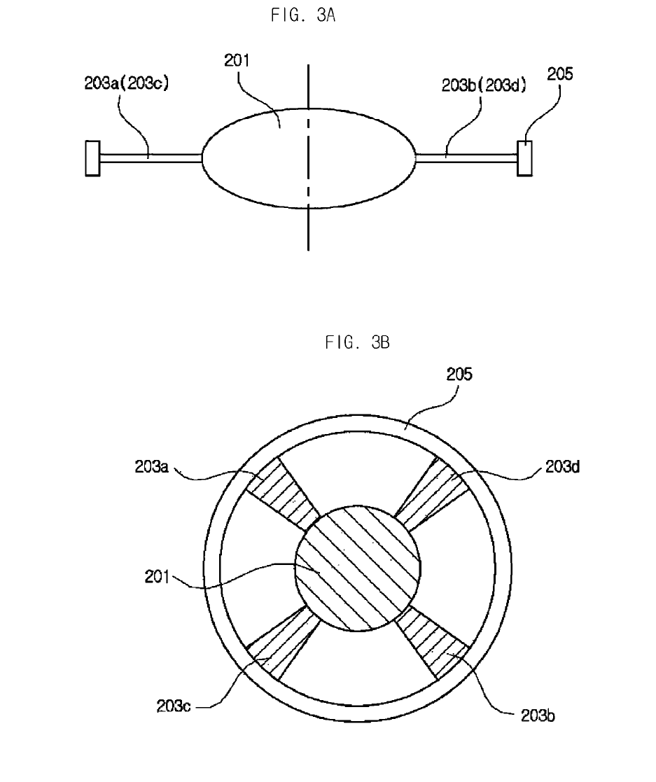

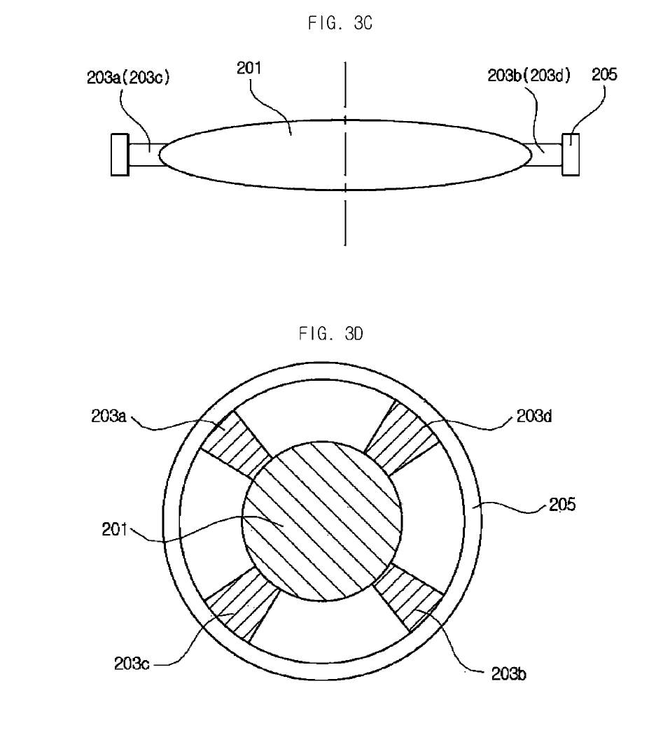

FIG. 3A is a schematic diagram showing a state in which an actuator of FIG. 2 is expanded, and FIG. 3B is a plan view corresponding to FIG. 3A.

Referring to FIGS. 3A and 3B, all the first, second, third, and fourth actuators 203a, 203b, 203c, and 203d expand. Accordingly, force is applied from the support 205 toward the center of the variable-shape lens 201, and the variable-shape lens 201 contracts. As a result, the thickness of the variable-shape lens 201 increases, and the width thereof decreases. According to such a change in shape, the focal length of the variable-shape lens 201 varies.

FIG. 3C is a schematic diagram showing a state in which the actuator of FIG. 2 is contracted, and FIG. 3D is a plan view corresponding to FIG. 3C.

Referring to FIGS. 3C and 3D, all the first, second, third, and fourth actuators 203a, 203b, 203c, and 203d contract. Accordingly, contractile force is applied to both ends of the first, second, third, and fourth actuators 203a, 203b, 203c, and 203d toward the centers thereof.

One end of each of the first, second, third, and fourth actuators 203a, 203b, 203c, and 203d is fixed at the support 205, and the support 205 is also fixed at another component (not shown). Therefore, the support 205 does not move even when the first, second, third, and fourth actuators 203a, 203b, 203c, and 203d contract and force is applied to the support 205 toward the center of the variable-shape lens 201.

Meanwhile, since the other end of each of the first, second, third, and fourth actuators 203a, 203b, 203c, and 203d is connected to the variable-shape lens 201, when the first, second, third, and fourth actuators 203a, 203b, 203c, and 203d contract, force is applied to the variable-shape lens 201 toward the support 205. At this time, the variable-shape lens 201 expands toward the support 205 due to its elasticity. As a result, the thickness of the variable-shape lens 201 decreases, and the width thereof increases. According to such a change in shape, the focal length of the variable-shape lens 201 varies.

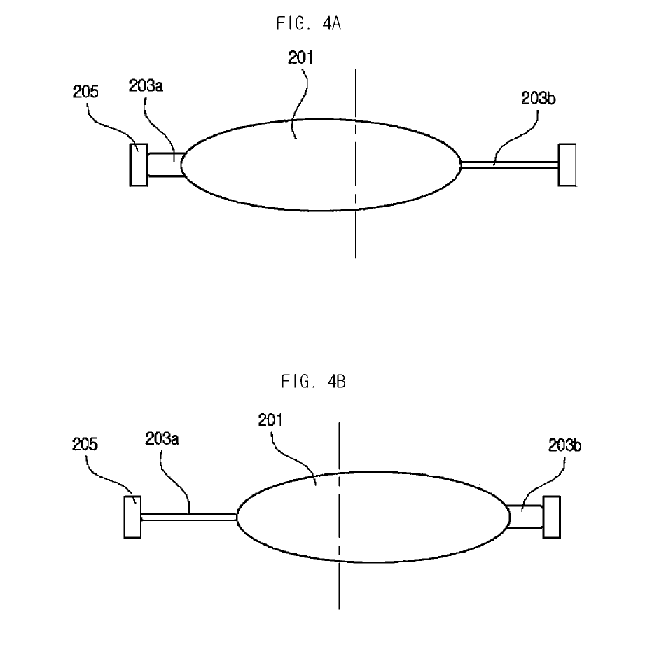

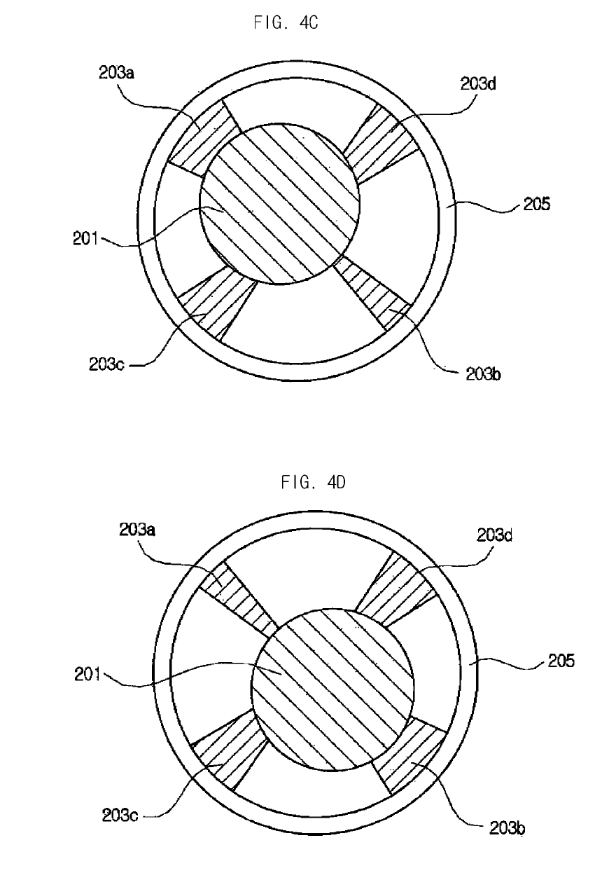

FIGS. 4A and 4B are schematic diagrams illustrating a method of adjusting the position of a variable-shape lens of FIG. 2, and FIGS. 4C and 4D are plan views corresponding to FIGS. 4A and 4B, respectively.

Referring to FIGS. 4A and 4C, the first actuator 203a contracts, and the second actuator 203b expands. The third and fourth actuators 203c and 203d do not vary in shape. Accordingly, force is applied to the variable-shape lens 201 toward the left side of FIG. 4A, and the variable-shape lens 201 moves.

On the other hand, referring to FIGS. 4B and 4D, the first actuator 203a expands, and the second actuator 203b contracts. The third and fourth actuators 203c and 203d do not vary in shape. Accordingly, force is applied to the variable-shape lens 201 toward the right side of FIG. 4B, and the variable-shape lens 201 moves.

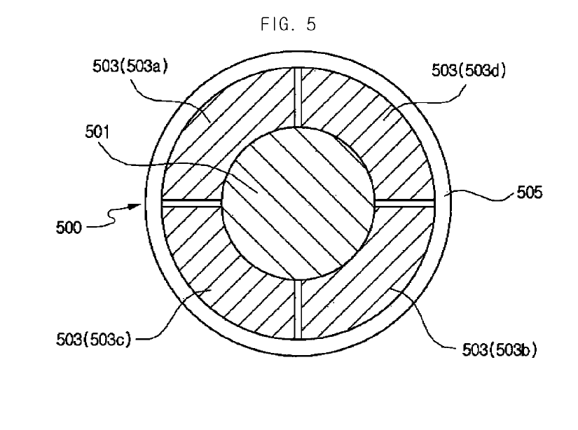

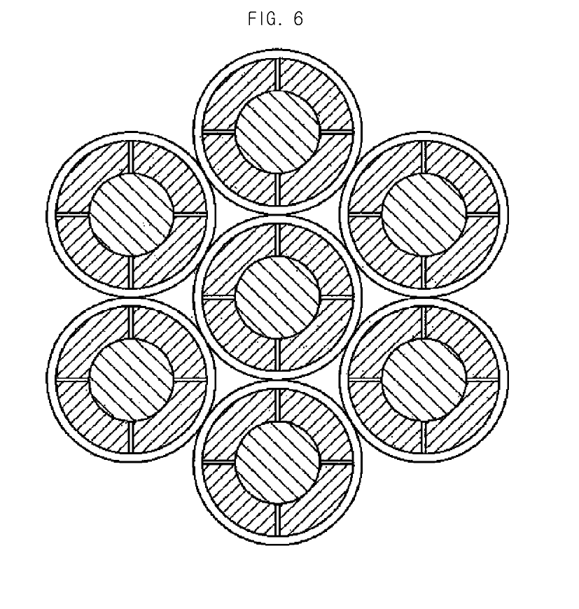

FIG. 5 is a schematic diagram showing a variable-shape optical element according to another exemplary embodiment of the present invention.

Referring to FIG. 5, a variable-shape optical element 500 according to another exemplary embodiment of the present invention includes a variable-shape lens 501, an actuator 503, and a support 505. The actuator 503 connected to the variable-shape lens 501 includes first, second, third, and fourth actuators 503a, 503b, 503c, and 503d. The spaces between the actuators 503a, 503b, 503c, and 503d are very small, and the actuators 503a, 503b, 503c, and 503d occupy most space between the variable-shape lens 501 and the support 505. When the actuator 503 is formed large in this way, the variable-shape lens 501 may be supported more stably. In this case, the actuator 503 and electrodes (not shown) connected thereto all may be formed of a transparent material. In addition, a plurality of such optical elements may constitute an array structure shown in FIG. 6.

As described above, in a variable-shape optical element according to an exemplary embodiment of the present invention, it is possible to freely control a change in the focal length of a variable-shape lens. Also, using an actuator that is variable in shape, it is possible to separately change the shape and the position of the variable-shape lens.

Meanwhile, in a variable-shape optical element according to an exemplary embodiment of the present invention, an actuator expands or contracts in a specific direction, thus changing the magnitude and the direction of force applied to a variable-shape lens. Therefore, the variable-shape lens varies in shape, and the position thereof may also be changed.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A variable-shape optical element, comprising:
a variable-shape lens;
an actuator connected to the variable-shape lens; and
a support configured to support the actuator,
wherein the actuator varies in shape according to an electrical signal.

2. The variable-shape optical element of claim 1, wherein the actuator includes:
a first actuator connected to a first portion of the variable-shape lens; and
a second actuator connected to a second portion of the variable-shape lens.

3. The variable-shape optical element of claim 2, wherein the first portion and the second portion are symmetric with respect to a center of the variable-shape lens.

4. The variable-shape optical element of claim 2, wherein the first actuator and the second actuator are separately controlled.

5. The variable-shape optical element of claim 4, wherein the actuator further includes:
a third actuator connected to a third portion of the variable-shape lens; and
a fourth actuator connected to a fourth portion of the variable-shape lens.

6. The variable-shape optical element of claim 5, wherein the third portion and the fourth portion are symmetric with respect to the center of the variable-shape lens.

7. The variable-shape optical element of claim 6, wherein the third actuator and the fourth actuator are separately controlled.

8. The variable-shape optical element of claim 7, wherein among the first actuator, the second actuator, the third actuator, and the fourth actuator, all pairs of actuators adjacent to each other make the same angle with the center of the variable-shape lens.

9. The variable-shape optical element of claim 1, wherein the actuator is formed of an electroactive polymer.
